(19) United States
(12) Patent Application Publication
(10) Pub. No.: US 2026/0253246 A1
(43) Pub. Date: Aug. 27, 2026

(54) METHOD FOR DETERMINING THE POSITION AND/OR ORIENTATION OF A SOCKET OF AN ELECTRIC CAR FOR THE PURPOSE OF AUTOMATICALLY PLUGGING IN A CONNECTOR

(71) Applicant: Rocsys B.V., Rijswijk (NL)

(72) Inventors: Kanter van Deurzen, Delft (NL); Toby Joannes Hijzen, Rijswijk (NL)

(21) Appl. No.: 18/724,581

(22) PCT Filed: Dec. 30, 2022
(86) PCT No.: PCT/EP2022/088101

§ 371 Date: Jun. 26, 2024

(30) Foreign Application Priority Data
Jan. 7, 2022 (NL) 2030458

(51) Int. Cl. G06T 7/73; H04N 23/60

(52) U.S. Cl. CPC G06T 7/73; H04N 23/60; G06T 2207/30252

(57) ABSTRACT

The present invention relates to a method for determining the position and/or orientation of a socket of an electric car for the purpose of automatically plugging in a connector, comprising providing a digital camera image of a region in which the presence of a socket is expected by means of a camera with settable parameters, recognizing the location of fiducial features within the digital camera image, using a feature recognition algorithm and determining the position and/or orientation of the socket based on the fiducial features in the digital camera image, characterised by setting at least one camera parameter for providing the digital camera image, such that the fiducial features are recognizable for the feature recognition algorithm, wherein the fiducial features are part of the connecting functionality of the socket.

### CROSS REFERENCE TO RELATED APPLICATIONS

This is the U.S. National Stage of International Application No. PCT/EP2022/088101, filed Dec. 30, 2022, which was published in English under PCT Article 21(2), which in turn claims the benefit of Netherlands Application No. 2030458, filed Jan. 7, 2022. The Netherlands application is incorporated herein in its entirety.

The present invention relates to a method for determining the position and/or orientation of a socket of an electric car for the purpose of automatically plugging in a connector. Automatically plugging in electric charging connectors in vehicle sockets has become a new goal for large fleet owners during recent years. Many electric vehicles have vehicle sockets meant for manually plugging in, such as vehicle sockets according to IEC 62196. The combination of connector and vehicle socket typically has a tightly fitting geometry. Hence, plugging it in automatically requires a certain degree of accuracy in positioning and orientating of the connector. The accuracy with which a vehicle socket is placed at an automatic charging station by a typical vehicle, such as a passenger car, over different charging instances is insufficient to facilitate automatically plugging in without determining the vehicle socket's position and orientation. Factors that contribute to the lack of accuracy are, for example, the motion accuracy of vehicles while parking, the variation of height and orientation of the socket over several connection cycles of one vehicle over time, and between vehicles in general, for example due to wear and tear and setting of suspension.

The connector or connectors at a charging station are held by an actuated mechanism that is able to move them toward a socket of a vehicle that is standing still, and to adapt its position and orientation such that it can be plugged in, with the aid of the same mechanism. For being able to do so, the socket's position and orientation have to be determined before plugging in. Evidently, this is to be done automatically too. This can be achieved in various ways with various means.

However, when only considering parts of the socket that contribute to the physical connecting functionality, i.e., the conductive pins, and non-conductive body, finding the socket's position and orientation is difficult. The non-conductive parts of a socket usually consist of black features, surrounded by a black circumference, which may as an extra complication always, or at one moment in time, be a poorly illuminated environment or circumstance, and at another location or at another moment in time be in a very bright environment. These factors make the determination of the position and orientation of the socket through feature recognition extra complex.

Several solutions have been proposed in the art so far. The Korean patent publication KR20190113697A discloses a first light control unit including a first lamp and a first illuminance sensor, a second light controller installed on the opposite side of the first light controller based on the charging connector and including a second lamp and a second illuminance sensor and a camera which operates by photographing the first lamp and the second lamp. The International patent application WO2021061354A1 discloses a system wherein a charge head is connected to a charge inlet of an electric vehicle to supply an electric charge to recharge the battery of the vehicle. The charge head is attached to a connecting device that moves the charge head to the charge inlet. Multiple light detectors are provided on the charge head to sense light emitted from the vehicle. The German patent publication DE102011080456A1 discloses an arrangement for supporting establishment of plug connection for e.g. a blind user for terminal of computer, having a detection unit for detection of proper setting or insertion of plug into component, and an output unit outputting information to a user. The US patent publication US2013293366A1 discloses a communication unit that periodically transmits a request signal toward a prescribed range. When a transmitter exists in the range where the request signal can be received, it sends identification information in a responsive manner.

Pan, et al, XP006092988 describes an automatic recognition and location system for electric vehicle charging port in complex environments. The system obtains the charging port posture through image processing, and performs the insertion motion in combination with the robot arm to complete the charging gun insertion of the automatic charging link. Pan et al, describes the use of five circular features to mimic the internal five metal cores of the socket. Pan et al, describes the use of high reflective material marking said five circular features so that based on those markers, the recognition and location of the charging port are studied. Images are subsequently processed in brightness and noise reduction in order better recognize said markers. The five circular features are either external to the socket geometry or added to mimic the internal five metal cores of the socket but are not deemed to have a connecting functionality.

All of the above-described systems have the disadvantage that means have to be added to the vehicle to facilitate the detection and estimation of the position and orientation of the socket, like introducing markers such as lights. This makes the system unsuitable for vehicles that haven't been prepared or optimized for those solutions. Moreover, those systems that are making use of cameras to record a view of the socket for trying to determine its position and orientation, face the difficulty that the socket is composed of a black front face or plane with holes that are also black, so that very little information is obtainable directly from that raw data. Many solution directions aimed to solve this problem try to enhance the image by illuminating the socket, either with a fixed or dynamic light source. They treat the dark socket as an object that needs illumination to let the camera function in a conventional way with conventional setting. This will help in some cases, but it does not allow for a lot of variation.

It is a goal of the present invention to propose a method and system for determining the position and/or orientation of a socket of an electric car for the purpose of automatically plugging in a connector of a charging station, that takes away the disadvantaged of the prior art, or at least forms a useful alternative therefore.

The invention thereto proposes a method for determining the position and/or orientation of a socket of an electric car for the purpose of automatically plugging in a connector, the socket comprising connecting functionality, the method comprising providing, by means of a camera with at least one settable parameter, a digital camera image of a region in which the presence of a socket is expected and the method comprises the steps of recognizing, using a feature recognition algorithm, the location of fiducial features within the digital camera image, wherein the fiducial features are part of the connecting functionality of the socket; determining the position and/or orientation of the socket based on the fiducial features in the digital camera image and setting at least one camera parameter for providing the digital camera image, such that in the digital camera image the fiducial features are recognizable for the feature recognition algorithm.

Fiducial features may be or form part of the connecting functionality of the socket, which in this context may comprise features of a charging socket with a documented geometry, for example defined in an international standard such as IEC 62196 or in another design specification, that are visible in recordings. Based on the output of a feature recognition algorithm to detect these fiducial features, a pose estimation algorithm can determine the position and/or orientation of the socket. The fiducial features may in general be recognizable by their shape, contrast, colour or the like. In this specific case, suitable aspects are typically gradients or abrupt transitions (edges), which may constitute curves or corners (of) holes or pins or other complex visual features. The connecting functionality may be formed of or comprise socket parts for electrically and/or mechanically and/or physically coupling a connector. Electrically insulating parts may be comprised as well. The (inverse) shape for receiving the connector in general may be seen as connecting functionality, as well as the conductive pins, and non-conductive body specifically. External markers, such as patches are generally deemed not to have a connecting functionality.

Several algorithms may be suitable for recognizing fiducial features. Examples are convolutional neural network algorithms or “You Only Look Once” (YOLO) models, among others.

Determining the position and/or orientation of the socket may be done with the aid of any suitable algorithm for pose estimation. Examples that may be applied are SolvePnP or Ransac, among others.

The method according to the invention provides as a first advantage that it is suitable for every vehicle (socket) without the requirement of any vehicle-side modification. Additionally, it makes use of the fact that enhanced information can be obtained from an image, in particular from an image that is particularly useful for feature recognition of dark objects, but not necessarily useful for something else. The digital camera image of a region in which the presence of a socket is expected may be an image from a camera specifically installed for using this method, either on or near an assembly that wields the connector, or it may be from a camera monitoring a parking lot for charging an electric vehicle, or any location where a socket may be expected in general. The presence of the vehicle may be announced automatically, by a detection system in the vicinity of the parking lot, an external system or by communication with the vehicle, or by using the camera that's also used for this invention

In an embodiment of the invention, changing at least one camera parameter is implemented as changing the exposure time of the camera. It should be noted here that throughout this application, reference is made in particular to digital cameras outputting a single, a sequence, or a stream of digital images. Terms derived from analogue photo, film, or video technology may be interpreted here as their digital equivalent.

The longer the exposure time a camera applies when obtaining an image, the “lighter” the image becomes. For some light areas in the image that may result in saturation, but for the darker areas this may result in lighter shades (for example lighter shades of grey) that were previously considered black or almost black. These values have found to provide better information for determining a socket's position and/or orientation.

Changing the exposure time may in general involve overexposing the image, which means that a number of (in particular light) colours end up outside the range that can be displayed.

In a further embodiment, the at least one camera parameter is the linear amplification gain of an analogue signal coming from a photo-sensitive cell comprised by the camera.

Increasing the amplifier gain scales the analogue signal coming from the photo-sensitive cell. As a result, the resulting image gets lighter without increasing the exposure time.

A particular embodiment of the gain is providing multiple digital camera images with different gain correction and forming one resulting image wherein for each pixel the most suitable corresponding pixel of one of the images is selected.

In another embodiment of the invention, changing at least one camera parameter is implemented as changing the aperture size of the camera.

By changing the aperture size of the camera, the amount of light that hits the camera sensor can be modified, which causes a variation in the digital camera brightness. This way, the same effect in the digital image already explained for the exposure time can be achieved.

In another embodiment, changing at least one camera parameter takes place by performing a gamma correction, where the digital signal is compressed or expanded exponentially with a factor gamma, which may be before storing the digital camera recording in a digital storage format, which nonlinearly changes the sensitivity to light. This may be used to increase the sensitivity to relative differences between darker shades, compared to the lighter shades.

In practice, a number of the camera parameters will be balanced such that they produce the optimal digital camera image for recognizing the fiducial features.

The camera parameters that are used, and what value they should have, may be determined either iteratively, that is by analysing an obtained image and taking a new image with amended settings, or it may be based on external sensors input, such as light sensors, calibrated values for constant lighting conditions, other information from external systems or a combination of them.

In an embodiment, the method according to the invention comprises determining a region of interest in the acquired camera image, the region of interest being the area in which a socket is detected. In an embodiment, the method according to the invention comprises determining a region of interest in the digital camera image including one or more of the fiducial features of the socket. In some cases, the method comprises determining a region of interest in the digital camera image, the region of interest being the area in which a socket is detected; wherein the digital camera parameters are set based on information from said region of interest, and in particular, information on the basis of which the at least one camera parameter is set is limited to the information from the region of interest. In some cases, adjusting the digital camera image is limited to adjusting the region of interest within the image. This makes the changes specifically useful for the region of interest. In addition, it may save computing time and consequently leads to a faster determination process and as a result thereof also to a faster plugging in sequence. In some cases, information on the basis of which the at least one camera parameter is set is limited to the information from the fiducial features of the socket. In some cases, the information on the basis of which the at least one camera parameter is set is limited to the information from a substantially non-reflective region of the socket. In some cases, information on the basis of which the at least one camera parameter is set is limited to the information from a substantially non-conductive region of the socket. Non conductive regions of the socket include the body of the socket and the cases that surround the conductive parts of the socket, i.e., the pins. In the context of the invention, a substantially non-reflective denotes a region which does not reflect substantial luminous radiation. In the context of the invention, non-conductive denotes non-electrically conductive.

In this context, the region of interest (ROI) is seen as an area in the digital camera image that contains the fiducial features of the charging socket. The digital camera image may contain at least one, more than one or all of the fiducial features of the charging socket. Preferably, the ROI can be considered as the set of pixels that constitute the convex hull around all pixels that are considered to be part of a fiducial feature.

In a preferred embodiment, the step of providing a digital camera image may comprise providing grey-scale images or grey-scale representations of an image. In some cases, the grey-scale image is made up of pixels represented as a bit value on an interval determined by the representation, such as the bit range, with increasing values from dark to light, and wherein the at least one camera parameter is adjusted such that that a predetermined target amount of pixels has a bit value equal or higher than a target bit value.

A digital image has a number of pixels. For a colour image, each pixel is represented by three bit values. Different representations are possible, such as the respective amounts or intensities of red, green and blue (RGB), or the values for hue, saturation and lightness/brightness (HSL and HSB). Alternatively, a grey-scale image, or a grey-scale representation of a colour image, only needs one bit value per pixel, to represent the lightness of a pixel.

The information contained in a colour image is bigger than in a grey-scale image, but when just looking for patterns or shapes, the information in grey-scale images is sufficient. Using a grey-scale image has the advantage that the complexity of the model, and therefore the need for complex hardware and software, is reduced. Nonetheless, in some cases a colour image may be utilized within the scope of the present invention.

In some cases, a colour image may be converted to grey-scale images via several methods. For example, using averaging of RGB values, or weighing the RGB values using the weights in the ITU-R BT 601 or the ITU-R BT 709 recommendation. The latter is preferred.

When analysing and adjusting the white balance and/or contrast in digital images, different values can be considered. One indicative combination is visualized when making a histogram of a recording in grey scale. The histogram shows the distribution of pixels along the grey scale.

For an 8-bit image of 2592×1944, each of the 5038848 pixels has a value on the interval from 0 to 255 (the bit range), increasing from dark to light. The horizontal axis of the histogram indicates a bit value along the bit range, while the vertical axis indicates the amount of pixels. Therefore, one point on the figure indicates the amount of pixels that have a given bit value.

Two indicative values for adjusting recording parameters are: the percentage of total pixels that have at least a certain bit value, and the percentage of the bit range represented by that bit value.

For example, for a normally balanced image, the aim is often to find camera settings that result in a suitable balance for the lighter features in an image. Someone skilled in the art would take a high bit value and a low percentage to achieve that result. I.e., the camera settings should be set such that a low amount of pixels have a relatively high value. A typical value is 13% of the pixels should have a bit value of 58% or higher.

For this invention, the aim is to find camera settings that result in a suitable balance for darker objects, as the charging socket consists of a black body, with black holes. Thereto, the invention aims to provide images that have a high amount of pixels with at least a relatively low bit value. This forces the darkest objects in the image to have at least a certain bit value, which makes the darker shades better distinguishable. Hence, the features of the charging socket are easier to detect. A side effect is that objects that are lighter than the socket could be considered as overexposed.

Preferably, the amount of pixels at a specified bit value should be above 75%, more preferably above 90% and most preferably above 99%. Preferably, the bit value should be above 6.25%, more preferably above 12.5%, and most preferably above 25% of the bit range.

Another aspect of the invention uses whether or not the features are recognizable to adjust the camera settings. For the features to be recognizable, there should be significant change in the absolute bit value between the pixels that represent the features. I.e. within the region of interest, the difference between the lightest pixel and the darkest pixel, excluding the pixels that are part of the conductive parts of the socket, should be larger than 20, more preferably larger then 30, or most preferably larger than 40.

The conductive parts of the socket are excluded, as they are usually reflective. In the context of this invention, that means they will usually be overexposed. That makes it difficult to distinguish.

Alternatively, when taking a sample of pixels that contain the whole, or a part of, a distinguishing aspect of the feature, such as an edge or a line, where the sample is an area of pixels that represents an area on or in the socket, the difference in absolute bit value between the lightest and darkest pixel in the sample should preferably be larger than 10, more preferably larger then 20, or most preferably larger than 30. Such area may have a size that is just sufficient to make fiducial features become detectable in the area. Such area may for instance be one or more square mm, for instance in the order of 3 mm×3 mm.

The method according to the invention may further comprise controlling a position and/or orientation of a connector on the basis of the determined position and/or orientation of the socket, more in particular inserting the connector into the socket.

The invention also relates to a device for determining the position and/or orientation of a socket of an electric car, comprising a camera and a processor for carrying out a method as described above. Evidently, the device may further comprise a connector for plugging into the socket, which connector may be coupled to a charging facility, which may also form part of the proposed solution according to the invention.

Such device may further comprise an actuated mechanism for moving a connector for charging an electric vehicle, adapted for controlling a position and/or orientation of the socket on the basis of the determined position and/or orientation of the socket. Devices that have proved to be very suitable for performing such automated plug-in sequence are described in patent applications of the same applicant, in particular numbers NL2023019, NL2024952, NL2025959, NL2026365, NL2026710 and NL2028169. These applications are herewith incorporated by reference. The devices described here may all be configured to perform the method according to the present invention.

The invention will now be elucidated into more detail with reference to the following figures, wherein:

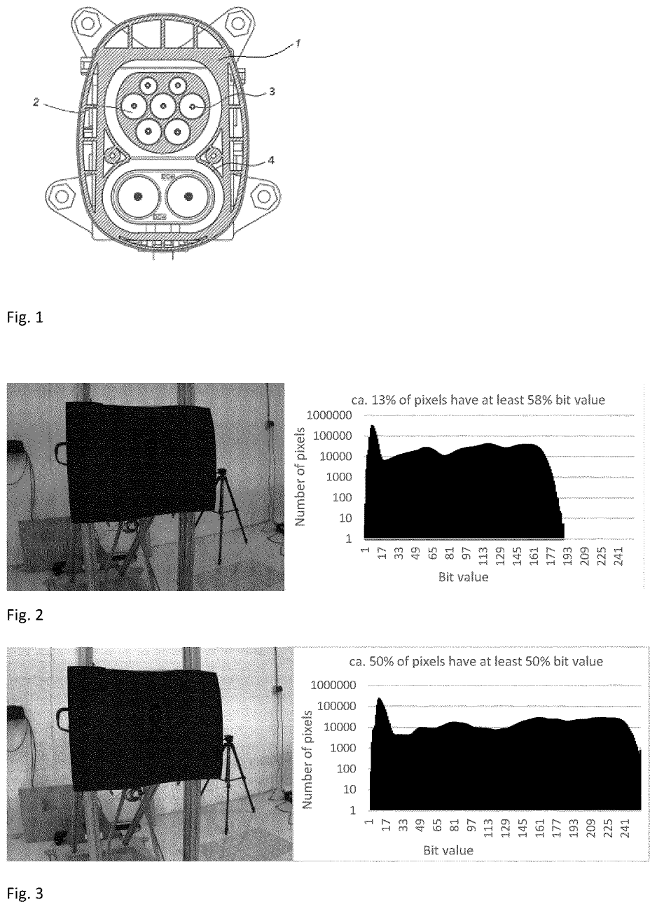

FIG. 1 shows the scheme of a socket, including the features relevant for establishing a charging connection.

FIG. 2 shows the image of charging socket where 13% of the pixels have a bit value of at least 58% of the bit range, and the histogram to illustrate the distribution of pixels.

FIG. 3 shows the image of a charging socket where 50% of the pixels have a bit value of at least 50% of the bit range, and the histogram to illustrate the distribution of pixels.

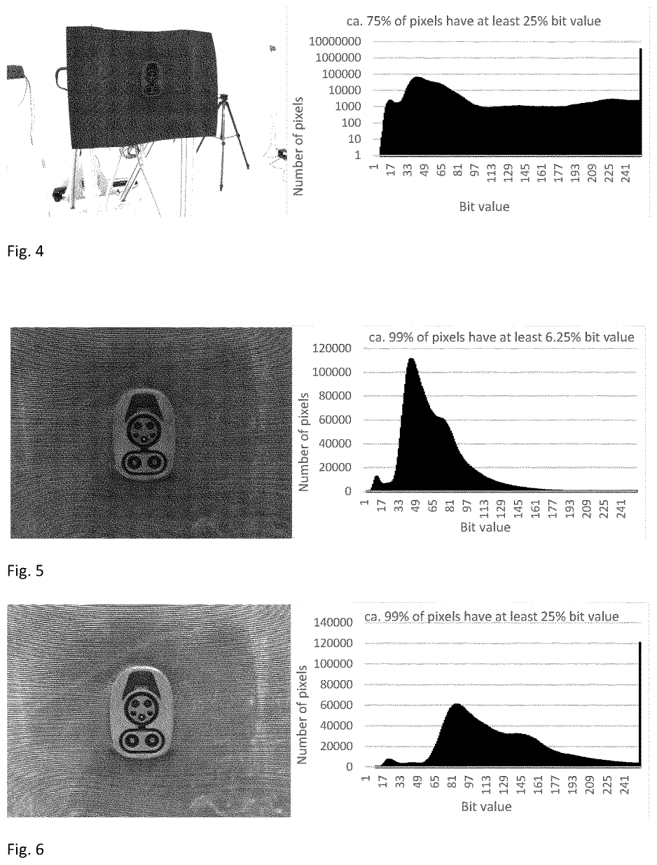

FIG. 4 shows the image of a charging socket where 75% of the pixels have a bit value of at least 25% of the bit range, and the histogram to illustrate the distribution of pixels.

FIG. 5 shows the image of a charging socket, where 99% of the pixels have a bit value of at least 6.25% of the bit range, and the histogram to illustrate the distribution of pixels.

FIG. 6 shows the image of a charging socket, where 99% of the pixels have a bit value of at least 25% of the bit range, and the histogram to illustrate the distribution of pixels.

FIG. 1 shows a cross section of a charging socket, which includes fiducial features that are part of the connecting functionality of the socket. In this specific case, the gradients and abrupt transitions (edges) to be recognizable for the feature recognition algorithm could constitute the curves or corners of the front face 1, holes 2, pins 3 or other defined curves 4.

FIG. 2 shows the result of using settings to reach conventional target values, while having both light and dark objects in the image.

FIG. 3 shows the result of using settings to reach target values in the middle of the ranges, with the same objects in the image as FIG. 2.

FIG. 4 shows the result of using settings to reach the preferred targets, with the same objects in the image as FIG. 2.

Comparing these figures shows that conventional and average settings favour visibility of the lighter objects, while the preferred settings favour visibility of the darker objects. In the histograms of FIGS. 2 and 3 this is seen as a disproportional peak at the left, while the histogram of FIG. 4 has a disproportional peak at the right. I.e. in conventional terms FIGS. 2 and 3 are underexposed, while FIG. 4 is overexposed. Moreover, visual examination shows that in FIGS. 2 and 3 the fiducial features of the connecting functionality are not, or not easily, recognized. In FIG. 4, however, they are recognizable.

FIG. 5 shows an image with only black objects, with the camera parameters configured to obtain the preferable target bit value, with the most preferable target amount of pixels.

FIG. 6 shows an image with only black objects, with the camera parameters configured to obtain the most preferable target bit value, with the most preferable target amount of pixels.

A comparison of the histograms of FIGS. 5 and 6 shows that with the most favourable target values the pixels are more distributed over the bit values. This indicates that there is more information available for feature recognition algorithms. The images and their histograms show that images according to the invention have clearly distinguishable features, while the others do not. In addition, the images according to the invention that have lighter objects are overexposed on the lighter objects.

1. Method for determining the position and/or orientation of a socket of an electric car for the purpose of automatically plugging in a connector, the socket comprising connecting functionality, comprising:
using a camera with at least one settable parameter to provide a digital camera image of a region in which the presence of a socket is expected;
recognizing, using a feature recognition algorithm, locations of fiducial features within the digital camera image, wherein the fiducial features are part of the connecting functionality of the socket;
determining the position and/or orientation of the socket based on the fiducial features in the digital camera image; and
setting at least one camera parameter for providing the digital camera image, such that in the digital camera image the fiducial features are recognizable for the feature recognition algorithm.

2. Method according to claim 1, wherein the at least one camera parameter is an exposure time.

3. Method according to claim 1, wherein the at least one camera parameter is a linear amplification gain of an analogue signal coming from a photo-sensitive cell comprised by the camera.

4. Method according to claim 1, wherein the at least one camera parameter is a camera aperture size.

5. Method according to claim 1, wherein the at least one camera parameter is a gamma correction, where the digital signal is amplified exponentially with a factor gamma.

6. Method according to claim 1, wherein setting at least one camera parameter is done based on external information, such as a signal from a light sensor, a calibrated value for constant lighting conditions or information from an external system.

7. Method according to claim 1, comprising determining a region of interest in the digital camera image including at least one fiducial features of the socket.

8. Method according to claim 1, wherein setting at least one camera parameter is done based on a previously recorded digital camera image.

9. Method according to claim 8, comprising determining a region of interest in the previously recorded digital camera image, the region of interest being the area in which a socket is detected, and wherein information on the basis of which the at least one camera parameter is set is limited to the information from the region of interest.

10. Method according to claim 1, wherein providing a digital camera image comprises providing a grey-scale image or grey scaling the obtained image.

11. Method according to claim 10, wherein the grey-scale image is made up of pixels represented as a bit value on an interval determined by the representation, such as the bit range, with increasing values from dark to light, and wherein the at least one camera parameter is adjusted such that that a predetermined target amount of pixels has a bit value equal or higher than a target bit value.

12. Method according to claim 11, wherein the at least one camera parameter is adjusted such that a predetermined target amount of pixels is at least 75%, more preferably at least 90% and most preferably at least 99%, and wherein the target bit value is preferably at least 6.25% of the maximum bit value, more preferably at least 12.5%, and most preferably at least 25%.

13. Method according to claim 1, wherein the at least one camera parameter is adjusted such that within the region of interest, an absolute difference in absolute bit value between a lightest pixel and a darkest pixel, excluding the pixels that show conductive parts of the connecting functionality of the socket, is larger than 20, more preferably larger than 30, and most preferably larger than 40.

14. Method according to claim 9, wherein distinguishing aspects of the fiducial features which are recognizable by the feature recognition algorithm include at least an edge or a line, and wherein the at least one camera parameter is adjusted such that when taking a sample of pixels that contain the distinguishing aspects, or a part thereof, the difference in the absolute bit value between the lightest pixel and the darkest pixel in the sample is preferably larger than 10, more preferably larger then 20, and most preferably larger than 30.

15. Method according to claim 1, wherein information on the basis of which the at least one camera parameter is set is limited to information from the fiducial features of the socket.

16. Method according to claim 1, wherein information on the basis of which the at least one camera parameter is set is limited to information from a substantially non-reflective region of the socket.

17. Method according to claim 1, wherein information on the basis of which the at least one camera parameter is set is limited to information from a substantially non-conductive region of the socket.

18. Method according to claim 1, wherein information on the basis of which the at least one camera parameter is set is limited to information from a darker region of the socket.

19. Method according to claim 1, comprising controlling a position and/or orientation of the connector on the basis of the determined position and/or orientation of the socket.

20. Device for determining the position and/or orientation of a socket of an electric vehicle comprising:
a camera with settable parameters;
a microprocessor configured for performing a method comprising
using the camera to provide a digital camera image of a region in which the presence of the socket is expected;
recognizing, using a feature recognition algorithm, the locations of fiducial features within the digital camera image, wherein the fiducial features are part of connecting functionality of the socket;
determining the position and/or orientation of the socket based on the fiducial features in the digital camera image;
setting at least one camera parameter for providing the digital camera image, such that in the digital camera image the fiducial features are recognizable for the feature recognition algorithm; and
an actuated mechanism for moving a connector for charging the electric vehicle, adapted for controlling a position and/or orientation of the connector on the basis of the determined position and/or orientation of the socket.
